(19) United States
(12) Patent Application Publication
(10) Pub. No.: US 2023/0372745 A1
(43) Pub. Date: Nov. 23, 2023

(54) BREATH PROTECTION DEVICE

(71) Applicant: Qatar Foundation for Education, Science and Community Development, Doha (QA)

(72) Inventors: Geoffrey Hicks, Doha (QA); Ahmad FARD, Doha (QA)

(21) Appl. No.: 18/031,122

(22) PCT Filed: Oct. 8, 2021
(86) PCT No.: PCT/QA2021/050020

§ 371 Date: Apr. 10, 2023

Related U.S. Application Data
(60) Provisional application No. 63/089,134, filed on Oct. 8, 2020.

(51) Int. Cl. A62B 18/00; A62B 18/04; A62B 18/08; A42B 3/20

(52) U.S. Cl. CPC A62B 18/003; A62B 18/045; A62B 18/08; A42B 3/20

(57) ABSTRACT

A breath protection device is provided. The breath protection device includes a head cover and a transparent face covering shield coupled to the head cover. The head cover and the transparent face covering shield define a breathing zone. The breath protection device further includes an air filtration unit configured to filter air from outside and an air circulation unit configured to provide the filtered air to the breathing zone, thereby forming a continuous protective air curtain therein.

### PRIORITY CLAIM

This application claims priority to U.S. Provisional Patent Application No. 63/089,134, filed on Oct. 8, 2020, the entire contents of which are hereby incorporated by reference and relied upon.

### BACKGROUND

The COVID-19 related exposure control measures, such as physical distancing, face masks, and regular hand washing/sanitizing, are having a measurable benefit at slowing the spread of the SARS-CoV-2 virus. Aligned with these measures, space suits, Powered Air Purified Respirators (PAPR), Self-Contained Underwater Breathing Apparatus (SCUBA), and Self-Contained Breathing Apparatus (SCBA) are aimed to create a controlled, fully contained safe breathing zone for the users. However, these specialized devices are designed for a specific purpose, require a special training, and are prohibitively expensive for the general consumers.

### SUMMARY

In light of the present disclosure, and without limiting the scope of the disclosure in any way, in an aspect of the present disclosure, which may be combined with any other aspect listed herein unless specified otherwise, an example embodiment of a breath protection device is provided. In one example, the breath protection device includes a head cover; a transparent face covering shield coupled to the head cover. The head cover and the transparent face covering shield define a breathing zone. The breath protection device further includes a High Efficiency Particulate Arrestor (HEPA) USB powered air filtration unit (e.g., BroadAirPro USB 3 speed vertical modular HEPA filtration unit) configured to filter air from outside, and an air circulation unit configured to provide the filtered air to the breathing zone, thereby forming a continuous personal protective air curtain therein.

According to another non-limiting aspect of the present disclosure, a breath protection device includes a head cover, a transparent face covering shield coupled to the head cover, and a gaiter detachably coupled to the transparent face covering shield. The head cover, the transparent face covering shield, and the gaiter define a breathing zone. The two layered gaiter functions to impede the release into ambient air, of exhaled respiratory droplets which was a requirement of the World Health Organization (WHO). Additionally, because of the gaiter thickness, it is designed to protect against potential bee and wasp stings. The use of the gaiter is optional depending upon the requirements of the user and any applicable regulation. The breath protection device further includes an air filtration unit configured to filter air from outside and an air circulation unit configured to provide an excess volume of the filtered air to flow rapidly along the inner visor part of the breathing zone, thereby forming a continuous protective air curtain therein.

Additional features and advantages are described herein, and will be apparent from the following Detailed Description and the figures.

### BRIEF DESCRIPTION OF THE FIGURES

Features and advantages of the present disclosure, including a breath protection device, described herein may be better understood by reference to the accompanying drawings in which:

FIG. 1 illustrates a front view of a breath protection device according to an example of the present disclosure.

FIG. 2 illustrates a perspective view of the breath protection device of FIG. 1.

FIG. 3 illustrates a side view of the breath protection device of FIG. 1.

FIG. 4 illustrates a front view of the breath protection device of FIG. 1 with a gaiter attached thereto.

FIG. 5 illustrates the gaiter of FIG. 4.

FIG. 6 illustrates a process of assembling a breath protection device according to an example of the present disclosure.

FIGS. 7(a) and 7(b) each illustrate a breath protection device according to an example of the present disclosure.

FIGS. 8(a) and 8(b) each illustrate a breath protection device according to an example of the present disclosure.

FIGS. 9(a) and 9(b) each illustrate a breath protection device according to an example of the present disclosure.

FIG. 10 illustrates an air dispersion clip according to an example of the present disclosure.

FIG. 11 illustrates an air circulation unit and a power bank according to an example of the present disclosure.

FIG. 12 illustrates a breath protection device with a holder according to an example of the present disclosure.

FIGS. 13(a), 13(b), and 13(c) illustrate a breath protection device with an air circulation unit and a power bank within a holder according to an example of the present disclosure.

FIGS. 14(a) and 14(b) illustrate a breath protection device with a fan concealment flap covering an air circulation unit, a power bank, and a holder according to an example of the present disclosure.

FIGS. 15(a) and 15(b) each illustrate a breath protection device according to an example of the present disclosure.

FIGS. 16(a) and 16(b) each illustrate a breath protection device according to an example of the present disclosure.

FIGS. 17(a) and 17(b) each illustrate a breath protection device according to an example of the present disclosure.

The reader will appreciate the foregoing details, as well as others, upon considering the following detailed description of certain non-limiting embodiments of the present disclosure including the breath protection device.

### DETAILED DESCRIPTION

The current COVID-19 related exposure control measures, such as COVID-19 testing, physical distancing, face masks, and regular effective hand washing or sanitizing, are having a measurable benefit at slowing the spread of the SARS-CoV-2 virus. However, instead of consumers having to rely on the use of questionable personal protection masks and supposedly safe distances that may not consider air currents, there is an urgent need to provide safer and reliable respiratory protection that incorporates passive but effective exposure controls.

Creating complete breathing zone isolation using an effective physical barrier promises to be a more effective and user-friendly tool to slow the spread of COVID-19 and also provides users protection from other airborne pathogens and particulates that are normally filtered out using a HEPA filtration for continued usefulness after the pandemic is subsided. Many individuals do not wear their face masks properly, and they are not educated on cross contamination which may occur when they remove their face masks, and they may still touch their face and eyes too much. With the ease of transmission of SARS-CoV-2 via respiratory droplets and aerosols, there is a need for a simple, effective, and affordable physical barrier to disrupt viral spread. The present disclosure may provide essential breathing zone separation and a physical touch barrier and require no special learning or skills on the part of the user.

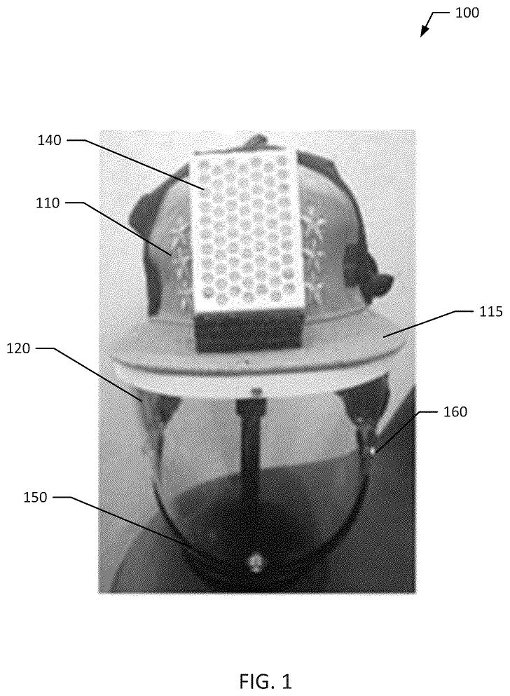

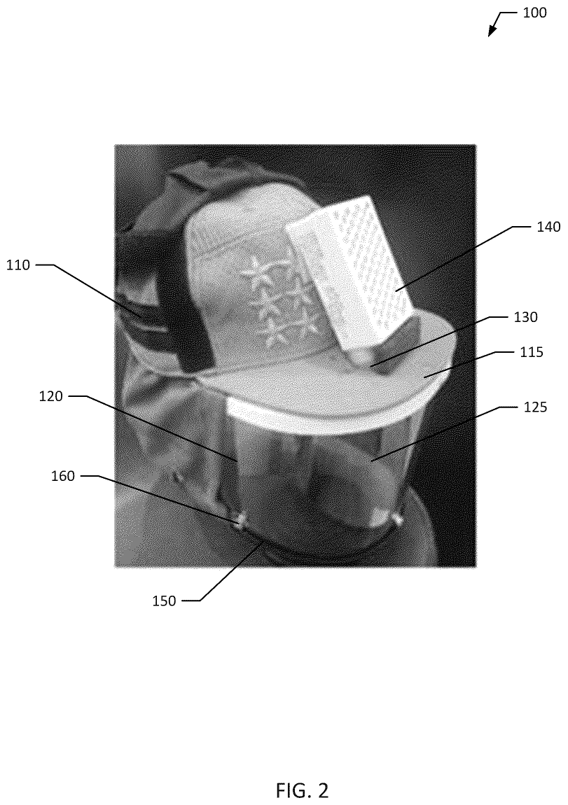

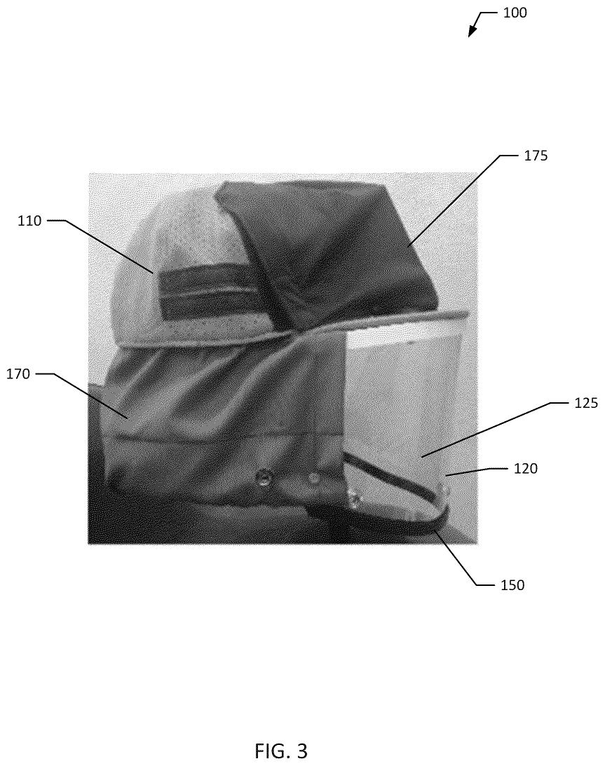

According to an embodiment of the present disclosure, a breath protection device 100 is provided. As illustrated in FIGS. 1 to 3, the breath protection device 100 may include a head cover 110 and a transparent face covering shield 120 coupled to the head cover 110. The head cover 110 and the transparent face covering shield 120 may define a breathing zone 125.

The breath protection device 100 can be made in a variety of typical hat sizes, using a polycarbonate upper shell, contoured to fit the profile and contours of the typical human head. Examples of the head cover 110 may include a hat (e.g., a baseball hat or any other suitable hat) for comfort and ease of use. The head cover 110 can be in any suitable size.

In some examples, the transparent face covering shield 120 may be made with a polycarbonate material. In other examples, the transparent face covering shield 120 may be made with any other suitable transparent material (e.g., other types of plastics). The transparent face covering shield 120 may be in a curved shape as illustrated in FIGS. 1-3. In other examples, the transparent face covering shield 120 may be in any other suitable shape (e.g., flat shape).

The face covering shield 120 may be configured to surround at least a face region of the user and can be further extended to surround a head region of the user. In some examples, the face covering shield or visor extends to the bottom of the face to allow for better face visibility. For example, the face covering shield 120 may have a top portion connected to the head cover 110 and a bottom portion extending around the neck or at least to around the chin region of a user.

The breath protection device 100 may further include an integrated air filtration unit 130 and an air circulation unit 140 with an on off switch and three fan speeds. The air filtration unit 130 filters air drawn from outside. The air filtration unit 130 may include a removable HEPA filtering material that is configured to filter out a predetermined percent (e.g., or 99% or more) of the smallest particles in the air in the range of 0.3 microns Aerodynamic Equivalent Diameter (AED). The air circulation unit 140 may provide the filtered air to the breathing zone 125, thereby forming a continuous protective air curtain therein. In some examples, the air circulation unit 140 may direct the filtered air to flow down (e.g., from the top near a front visor 115 of the head cover 110 to the bottom near the lower portion of the face covering shield 120) within the breathing zone to form the continuous protective air curtain. The downward flow of the clean filtered air may restrict unfiltered air from coming into the breathing zone 125 against the downward air current.

In some examples, the air filtration unit 130 and the air circulation unit 140 may be provided on, but not limited to, the head cover 110. For example, the air filtration unit 130 and the air circulation unit 140 may be provided on a front visor 115 of the head cover 110. The air filtration unit 130 may sit on the top or bottom portion of the air circulation unit 140.

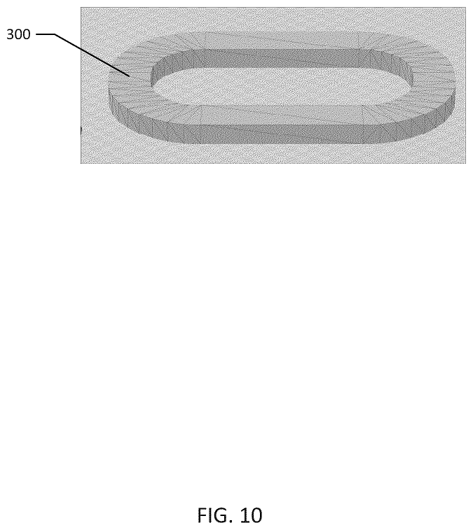

In some examples, the air circulation unit 140 may include a fan. For example, the air circulation unit 140 may include a laterally mounted USB computer cooling fan drawing air through the filtering material. The fan may be configured to draw fresh air through the air filtration unit 130, and blow air over the face and into the breathing zone 125 for cooling and maintaining appropriate humidity and CO₂ levels in the breathing zone 125. The air flow may be directed to prevent condensation on at least the front portion of the face covering shield 120. In some examples, the air circulation unit 140 may include an on-off and variable speed controller. In some examples, the air circulation unit 140 may further include an air dispersion nozzle to achieve maximum air velocity and localization in the air curtain for effective air flow. As shown in FIG. 10, the air circulation unit 140 may include an air dispersion clip 300 for the air dispersion/outflow nozzle.

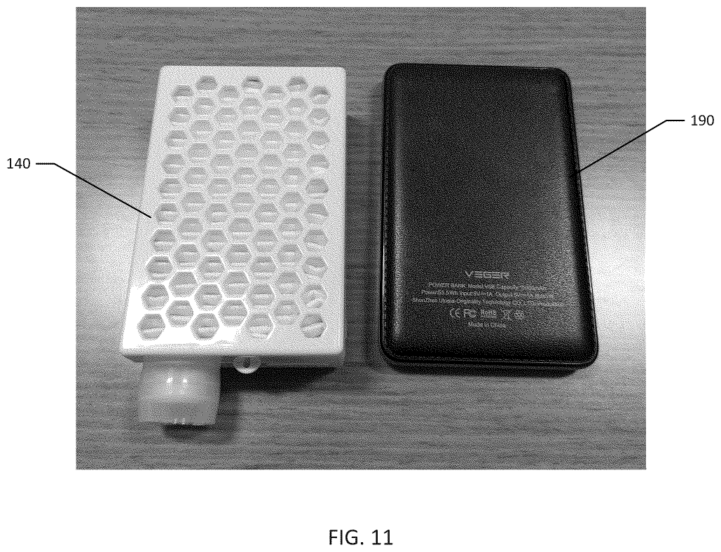

In some examples, the air circulation unit 140 may include one or more high-volume motors that, based on endurance testing, can run continuously for over 40 hours from a 25,000 mAh chargepak. In some examples, the air circulation unit 140 may operate based on an internal power source. In some examples, the breath protection device 100 may further include an external power bank (e.g., a power bank 190 as shown in FIG. 11) configured to provide additional power to the air circulation unit 140 (e.g., when needed for extended use requirements, such as during a 14 hour flight).

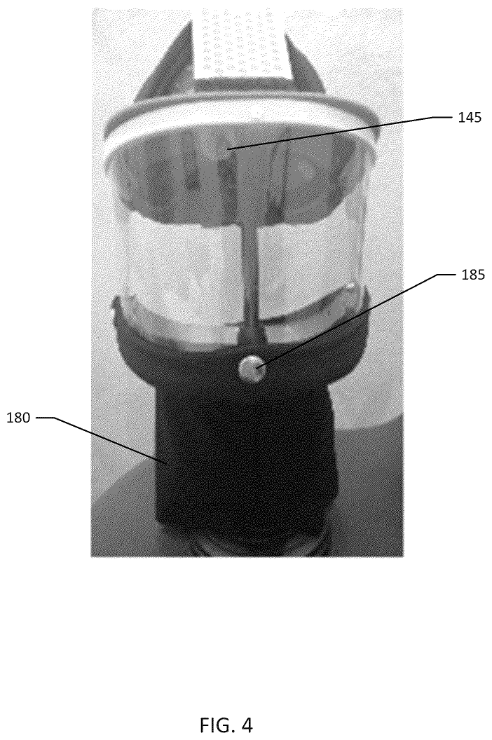

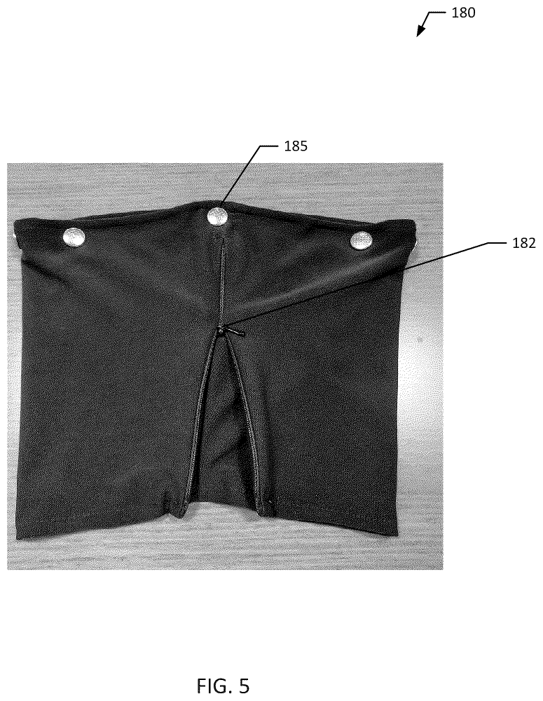

As illustrated in FIGS. 4 and 5, in some examples, the breath protection device 100 may further include a gaiter 180 (e.g., a filtering fabric skirt gaiter). The gaiter 180 may be detachably coupled to the transparent face covering shield 120. The gaiter 180 may secure around the neck and/or tuck in to the shirt below. The gaiter 180 can be easily attached around the bottom portion of the face covering shield 120 to enclose the breathing zone 125. The gaiter 180 may be detachably attached to the bottom portion of the face covering shield 120. The head cover 110, the face covering shield 120, and the gaiter 180 may define an enclosed breathing zone for the user. The gaiter 180 may be stretchable. Because the gaiter 180 can be removed from the face covering shield 120, it may allow the user to easily take off the breath protection device 100.

The gaiter 180 may be made of a fabric material and with adequate air permeability/filtration so as to allow the exhaled breath to escape from the enclosed breathing zone. The gaiter 180 may include a multilayer of suitable fabrics to effectively inhibit the release of droplets or aerosols in the exhaled breath.

In some examples, the breath protection device 100 may further include a lower frame 150 disposed on a lower portion of the transparent face covering shield 120. In some examples, the lower frame 150 may be made with malleable aluminum which can be bent to allow the lower dimensions of the visor to be varied to accommodate beards and personal preferences.

In some examples, the gaiter 180 may be detachably coupled to the lower frame 150. For example, the gaiter 180 may be detachably coupled to the lower frame 150 through a snap fastener. The snap fastener may include a male snap fastener and a female snap fastener. In some examples, the lower frame 150 may include one or more male snap fasteners 160, and the gaiter 180 may include one or more female snap fasteners 185. In other examples, the lower frame 150 may include one or more female snap fasteners, and the gaiter may include one or more male snap fasteners. In other examples, the gaiter 180 may be detachably coupled to the lower frame 150 through any other suitable detachable fastener (e.g., hook-and-loop fastener, magnet, zipper, etc.).

In some examples, the gaiter 180 may further include a vertical zipper 182. This zipper feature may allow for easy donning and doffing of the breath protection device. The zippered gaiter 180 may lightly seal around the user's neck and can be partially opened using the fastener (e.g., snap fasteners onto a defined firm support ring). In some example, the gaiter 180 may be double-layered. In other example, the gaiter 180 may have any suitable number of layer (e.g., single, triple, etc.). The gaiter 180 may be sufficiently thick to make it very difficult for a wasp or bee stinger to reach the skin. The gaiter fabric can be sprayed with an essential oil, such as peppermint oil, which may be a strong deterrent to bees and wasps. The gaiter 180 can be washed using normal gentle washing procedures.

In some examples, the breath protection device 100 may further include a lower back head cover 170 to cover the lower back head side of the user and a fan concealment flap 175 to cover the air filtration unit 130 and the air circulation unit 140.

The breath protection device 100 may keep the skirt/gaiter 180 away from touching the chin area, allow a convenient access mechanism for eating and/or drinking, and allow the opportunity to briefly release just the front portion of the skirt/gaiter 180. For example, aspects of the present disclosure may provide a continuous protective air curtain of clean filtered air over the breathing zone of the user, even when the user has opened the gaiter to allow access to the user's mouth for eating or drinking.

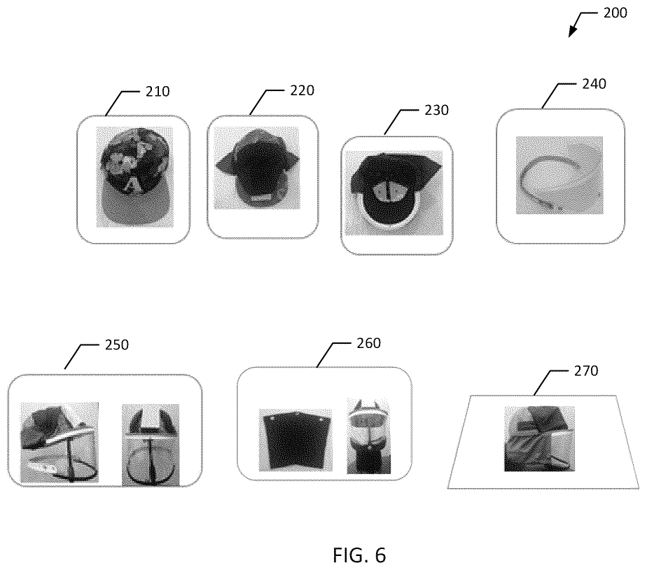

FIG. 6 illustrates a process 400 of producing a breath protection device according to an example of the present disclosure. Although the example assembly process 200 is described with reference to the flowchart illustrated in FIG. 6, it will be appreciated that many other processes may be used. For example, the order of some of the blocks may be changed, certain blocks may be combined with other blocks, and some of the blocks described are optional.

As illustrated in FIG. 6, a head cover (e.g., flat brim cap) may be provided (block 210). Then, a tight weave fabric may be attached to the head cover (block 220) and an upper visor support bracket is attached (block 230). A visor (face covering shield 120) and a lower frame (e.g., a shape ring) with snap fasteners may be provided (block 240). In some examples, a shape ring may also be provided in the lower most part of the cap and surround the back of the neck of the user. The head cover may be assembled with the face covering shield, the lower frame, an air filtration unit, and an air circulation unit (block 250). Then, the double layered zippered gaiter may snap on to the lower part of the face covering shield and shape ring (block 260). Then, a fan concealment flap may be attached to the head cover (block 270).

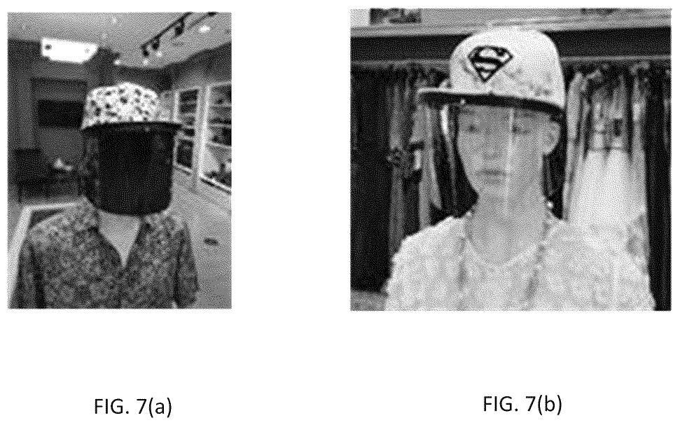

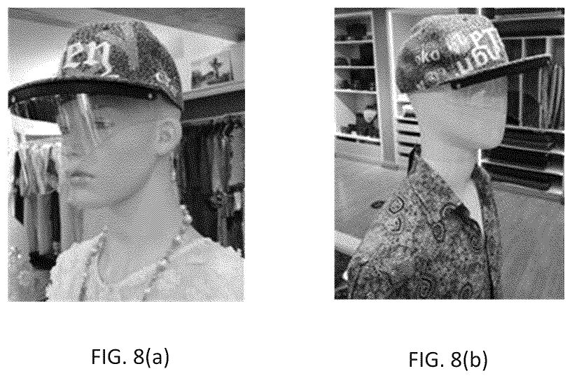

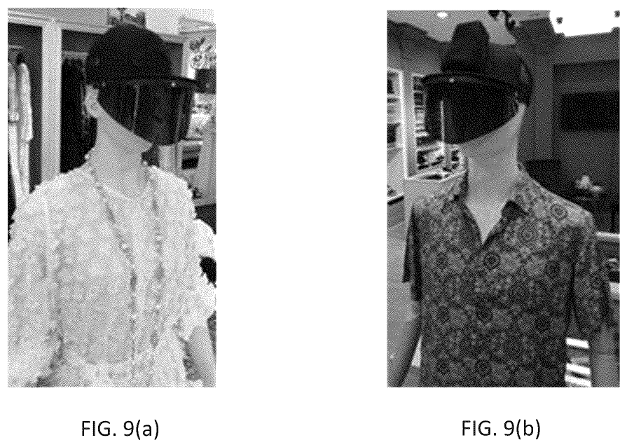

FIGS. 7(a), 7(b), 8(a), 8(b), 9(a), and 9(b), each illustrate a breath protection device in a different design without a gaiter according to other examples of the present disclosure. As illustrated in FIGS. 7(a) and 7(b), in some examples, the bottom portion of the transparent face covering shield may extend around the neck of a user, thereby covering almost the entire face of the user. As illustrated in FIGS. 8(a), 8(b), 9(a), and 9(b), in other examples, the bottom portion of the transparent face covering shield may extend only around the chin (in the middle portion of the face covering shield) and/or the cheek/cheekbone (in the side portions of the face covering shield) of a user, thereby covering only about half of the user's face. As illustrated in FIGS. 7(a), 9(a), and 9(b), in some examples, the transparent face covering shield may be tinted, which may provide a UV protection.

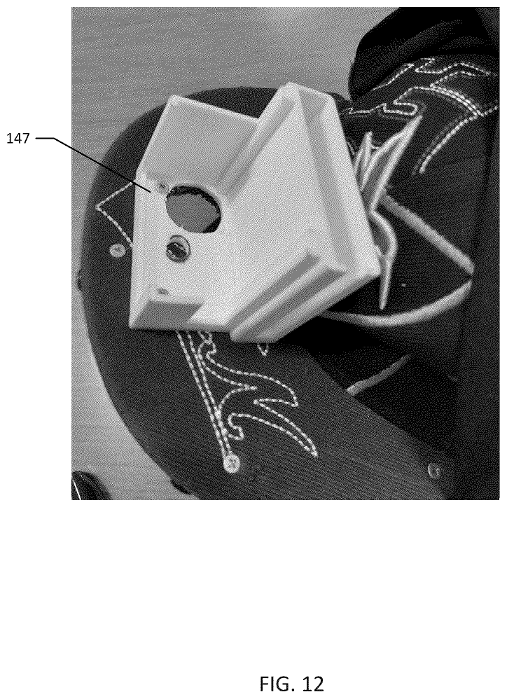

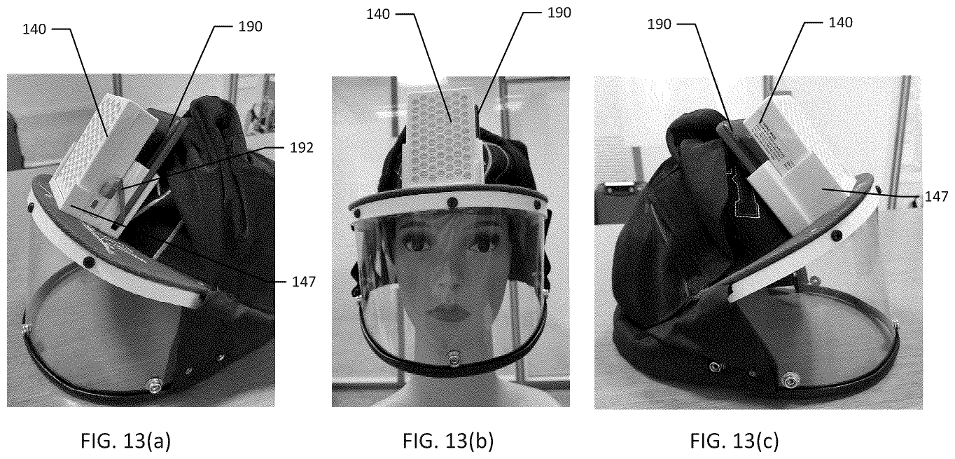

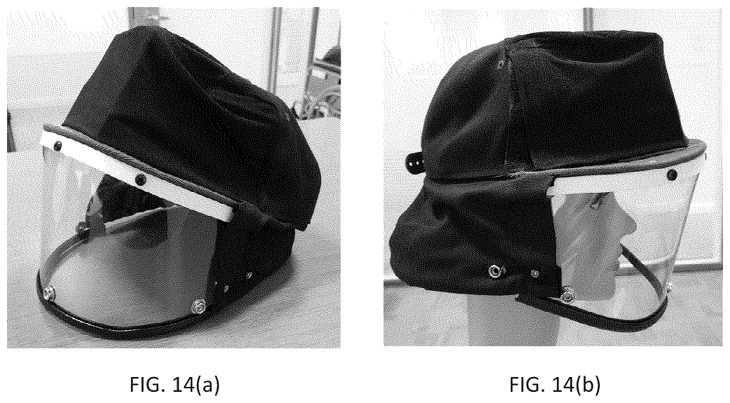

FIG. 11 illustrates the air circulation unit 140 and the power bank 190. In some examples, as shown in FIG. 12, a breath protection device may include a holder 147. As shown in FIGS. 13(a), 13(b), and 13(c), the holder 147 may be configured to hold the air circulation unit 140 and the power bank 190. The breath protection device may further include a power cable 192 that is configured to deliver the power from the external power bank 190 to the air circulation unit 140. In some examples, as shown in FIGS. 14(a) and 14(b), the breath protection device may cover the air circulation unit 140, the power bank 190, and the holder 147 using a fan concealment flap.

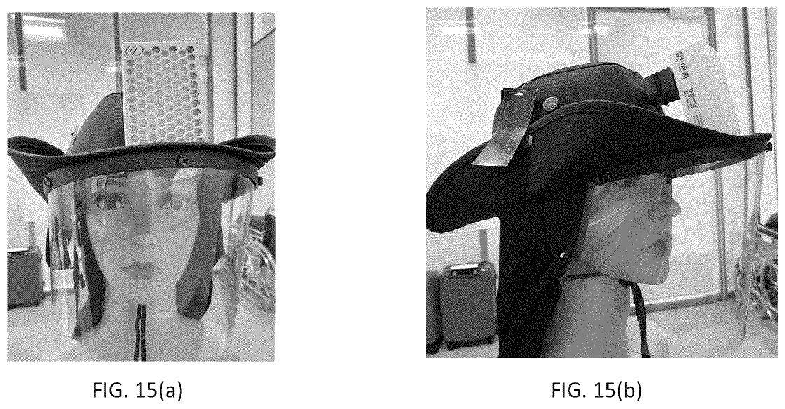

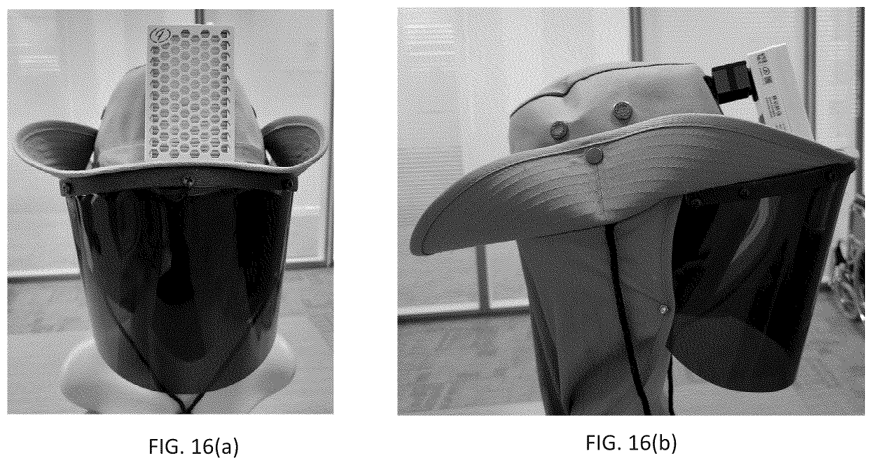

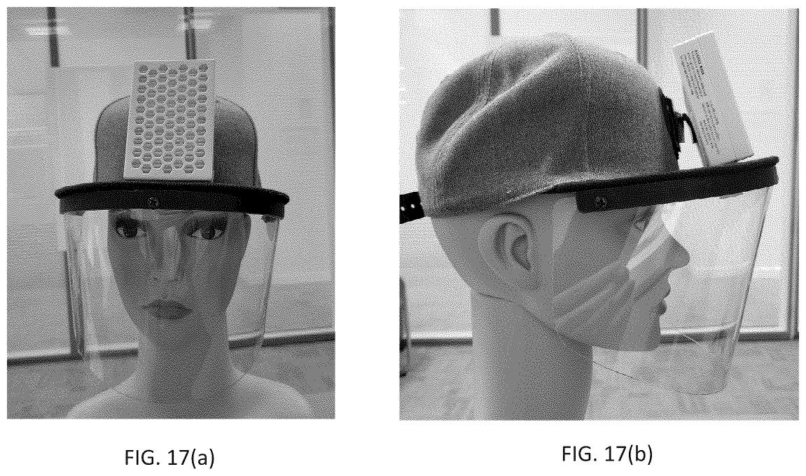

FIGS. 15(a) and 15(b) illustrate a breath protection device in a cowboy design without the fan concealment flap. FIGS. 16(a) and 16(b) also illustrate a breath protection device in another cowboy design without the fan concealment flap. In FIGS. 16(a) and 16(b), the transparent face covering shield may be tinted. FIGS. 17(a) and 17(b) illustrate a breath protection device in a different design without the fan concealment flap.

The breath protection device according to an example of the present disclosure may rely on a low-cost, user-friendly, and easy to wear self-contained breathing hood. This may effectively eliminate the spread of exhaled respiratory droplets and aerosols; self-inoculation by touching one's nose, mouth, or eyes; and has the real potential to drastically reduce person-to-person disease transmission. In addition, the passive protection provided by the breath protection device may make it ideal for children, seniors, and vulnerable populations who may find it difficult to follow the COVID-19 exposure reduction strategies.

According to an embodiment of the present disclosure, the flexible breathing zone design may be integrated into a hat, such as a baseball hat or the like, for comfort and ease of use. The airtight materials and design may need to also conform to compact streamlined dimensions for maximum wear, comfort, and appeal. The bottom skirt/gaiter of the breath protection device may be configured to secure lightly around the neck and tuck in under the wearers clothing. A typical PAPR may require 6 cubic feet per minute of air, and the breathing zone may be kept at slight positive pressure by the incoming clean air supply. The flexible breathing zone may provide a defined acceptable low-cost flexible barrier that may allow for a clean safe breathing zone and eliminate personal touching of mouth, nose, and eyes. Persons wearing the breath protection device may not spread potentially infective respiratory droplets and aerosols.

Examples of the advantages of the breath protection device according to the present disclosure may include: (1) providing a reliable affordable physical barrier between the person wearing this personal protective equipment and their external environment, and (2) helping stop the chain of transmission of infective airborne or surface deposited viral particles and provide the user with a level of comfort.

The breath protection device according to the present disclosure may be suitable for everyday indoor and outdoor use. For example, one targeted use may be for air travelers. Using a comfortable affordable personal breathing zone, and supplied air from the HEPA-filtered overhead air dispersions nozzles, the air traveler could spend their time, even on a long flight, with minimal viral exposure risk. Additionally, the breathing zone may provide an effective barrier that may prevent hands from touching one's eyes, nose, mouth, or other facial contact areas. Airlines may need some options to reassure hesitant air travelers that their risk of becoming ill is minimal. This solution may eliminate the need for separate breathing masks and/or googles. According to an example of the present disclosure, the breath protection device may have a global commercial application for everyday indoor and outdoor use, such as commercial airlines, public health agencies, and general consumer markets. Aspects of the present disclosure may also serve a broad and diverse recreation and industrial market, including walking and hikers' protection from ticks and insects, outdoor work, smog and dust protection, hobbyists needing breathing and face protection, beekeepers, sand blasting and grinding, face and head protection in cold environments, and so on.

The breath protection device according to the present disclosure may be as easy as a hat to wear and yet remove the need for wearing a nose/mouth face mask and goggles, while the cost is low, which may make it very attractive to consumers. Some advantageous features of the breath protection device according to an example of the present disclosure may include: (1) eliminating potential unconscious face (nose, mouth, eyes) touching with potentially contaminated hands; (2) preventing wearers from releasing exhaled respiratory droplets and aerosols into the air and potentially endangering others; (3) eliminating the discomfort of prolonged wearing of a face contacting mask or goggles; (4) providing air filtration equivalent to acceptable CDC guidelines for face masks; (5) providing a built-in USB-powered cooling fan that may direct the air movement to help maintain head cooling and visor clarity; (6) using polycarbonate lens material for its lightness, strength, and optical clarity; (7) forming “baseball” hat design for comfort and stability rather than a “non-fitted PAPR bag” over the head; (8) that children and elderly could safely and easily wear the safe breathing space without special training (the attached filtration materials can be periodically changed by a person who has read the instruction brochure); (9) that a modified enclosed bicycle helmet design could offer protection and cooling for cyclists who are at risk for inhaling excessive particulate matter while cycling in some areas; and (10) that the cost of the breath protection device may be far less expensive than PAPRs used in the industry and health care settings.

Reference throughout the specification to “various aspects,” “some aspects,” “an example,” “some examples,” “other examples,” or “one aspect” means that a particular feature, structure, or characteristic described in connection with the aspect is included in at least one example. Thus, appearances of the phrases “in various aspects,” “in some aspects,” “certain embodiments,” “an example,” “some examples,” “other examples,” “certain other embodiments,” or “in one aspect” in places throughout the specification are not necessarily all referring to the same aspect. Furthermore, the particular features, structures, or characteristics illustrated or described in connection with one example may be combined, in whole or in part, with features, structures, or characteristics of one or more other aspects without limitation.

It is to be understood that at least some of the figures and descriptions herein have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein.

The terminology used herein is intended to describe particular embodiments only and is not intended to be limiting of the present disclosure. As used herein, the singular forms “a,” “an,” and “the” are intended to include the plural forms as well, unless otherwise indicated. It will be further understood that the terms “comprises” and/or “comprising,” when used in this specification, specify the presence of stated features, integers, steps, operations, elements, and/or components, but they do not preclude the presence or addition of one or more other features, integers, steps, operations, elements, components, and/or groups thereof. As used herein, the term “at least one of X or Y” or “at least one of X and Y” should be interpreted as X, or Y, or X and Y.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A breath protection device, comprising:
a head cover;
a transparent face covering shield coupled to the head cover, wherein the head cover and the transparent face covering shield define a breathing zone;
an air filtration unit configured to filter air from outside; and
an air circulation unit configured to provide the filtered air to the breathing zone, thereby forming a continuous protective air curtain therein.

2. The breath protection device of claim 1, further comprising a gaiter detachably coupled to the transparent face covering shield.

3. The breath protection device of claim 2, wherein the gaiter is stretchable.

4. The breath protection device of claim 2, further comprising a lower frame disposed on a lower portion of the transparent face covering shield.

5. The breath protection device of claim 4, wherein the gaiter is detachably coupled to the lower frame.

6. The breath protection device of claim 5, wherein the gaiter is detachably coupled to the lower frame through a snap fastener.

7. The breath protection device of claim 1, wherein the transparent face covering shield comprises a polycarbonate material.

8. The breath protection device of claim 1, wherein the transparent face covering shield comprises a curved portion.

9. The breath protection device of claim 1, wherein the air circulation unit comprises a USB fan.

10. The breath protection device of claim 1, wherein the filtered air flows down within the breathing zone.

11. The breath protection device of claim 1, wherein the air filtration unit and the air circulation unit are disposed on the head cover.

12. The breath protection device of claim 11, wherein the air filtration unit and the air circulation unit are disposed on a visor portion of the head cover.

13. The breath protection device of claim 1, further comprising an external power bank configured to provide power to the air circulation unit.

14. A breath protection device, comprising:
a head cover;
a transparent face covering shield coupled to the head cover;
a gaiter detachably coupled to the transparent face covering shield, wherein the head cover, the transparent face covering shield, and the gaiter define a breathing zone;
an air filtration unit configured to filter air from outside; and
an air circulation unit configured to provide the filtered air to the breathing zone, thereby forming a continuous protective air curtain therein.

15. The breath protection device of claim 14, further comprising a lower frame disposed on a lower portion of the transparent face covering shield.

16. The breath protection device of claim 15, wherein the gaiter is detachably coupled to the lower frame through a snap fastener.

17. The breath protection device of claim 14, wherein the transparent face covering shield comprises a polycarbonate material.

18. The breath protection device of claim 14, wherein the air circulation unit comprises a USB fan, and the filtered air flows down within the breathing zone.

19. The breath protection device of claim 14, wherein the air filtration unit and the air circulation unit are disposed on a visor portion of the head cover.

20. The breath protection device of claim 14, further comprising an external power bank configured to provide power to the air circulation unit.
